(19) United States
(12) Patent Application Publication
(10) Pub. No.: US 2020/0027179 A1
(43) Pub. Date: Jan. 23, 2020

(54) APPARATUSES, METHODS AND SYSTEMS FOR TRANSFORMING ILLIQUID EQUITY PLATFORM

(71) Applicant: BuyWiser Technology, Inc., Santa Rosa Valley, CA (US)

(72) Inventor: Bennett Liss, Agoura Hills, CA (US)

(73) Assignee: BuyWiser Technology, Inc., Santa Rosa Valley, CA (US)

(21) Appl. No.: 16/517,421

(22) Filed: Jul. 19, 2019

Related U.S. Application Data
(60) Provisional application No. 62/701,756, filed on Jul. 21, 2018.

(51) Int. Cl. G06Q 50/16; G06Q 10/10; G06Q 30/02

(52) U.S. Cl. CPC G06Q 50/163; G06Q 30/0283; G06Q 10/10

(57) ABSTRACT

The APPARATUSES, METHODS AND SYSTEMS FOR TRANSFORMING ILLIQUID EQUITY PLATFORM (hereinafter “TIE”) transforms a generated property owner broker sales commitment message via TIE components into a distributed payment. More specifically, transforms commitment message, e-commitment messages, sale price actual commission messages via TIE components into commission payment distribution amounts.

This application is claims benefit of U.S. App. No. 62/701,756, filed Jul. 21, 2018, which are incorporated by reference.

### FIELD OF THE INVENTION

The present innovations are directed generally to finance, and more particularly, to APPARATUSES, METHODS AND SYSTEMS FOR TRANSFORMING ILLIQUID EQUITY PLATFORM.

### BACKGROUND OF THE INVENTION

Parties to a real estate transaction enter into an agreement with a licensed real estate broker on two occasions. The first is to purchase property. The second is to sell the property they purchased. Some sell “by owner.” Others move more often. In the real estate industry, client acquisition may include search and information costs. Search costs may include those incurred in determining if a property is available on the market. Information costs may include listing the property in an effort to solicit offers. Additionally, it is not uncommon for a real estate broker to hold an open house with hors d'oeuvres and refreshments in an attempt notify potential homebuyers of availability in the market. The real estate broker is also generally responsible for educating their clients on and obtaining the paperwork, forms and credit approvals for closing on a sale of real estate. To offset the client acquisition costs, real estate brokers generally receive a substantial commission, usually a percentage of the sale price

### SUMMARY OF THE INVENTION

Briefly, and in general terms, the invention provides APPARATUSES, METHODS AND SYSTEMS FOR TRANSFORMING ILLIQUID EQUITY PLATFORM (hereinafter “TIE”) transforms a generated property owner broker sales commitment message via TIE components into a distributed payment. More specifically, transforms commitment message, e-commitment messages, and sale price actual commission messages via TIE components into commission payment distribution amounts.

For purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1 shows one example of the TIE platform;

FIG. 2 illustrates some of the transforming aspects in one embodiment of TIE operations.

FIG. 3 illustrates aspects of one embodiment of TIE operations.

FIG. 4 illustrates one embodiment of the TIE controller.

### DETAILED DESCRIPTION OF THE PREFERRED EMBODIMENTS

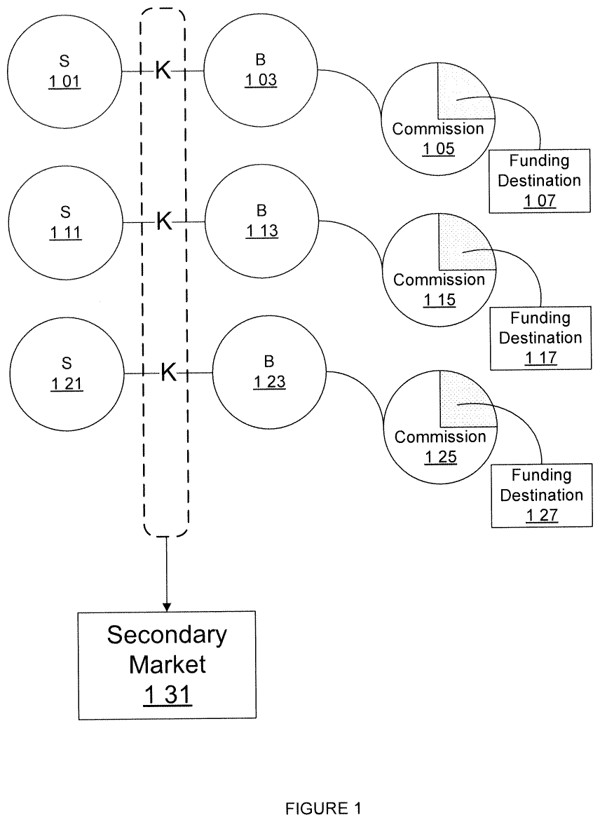

FIG. 1 shows a schematic diagram illustrating one example of the TIE embodiment. As FIG. 1 illustrates, one embodiment may include a set of sellers 101, 111 and 121; a set of buyers 103, 113 and 123; a set of commissions 105, 115 and 125; a set of funding destinations 107 117 and 127; and a secondary market 131. In one embodiment, the TIE operations may include a property owner making a commitment to list their property with a broker in advance.

The “property owner broker sales commitment” can also be referred to throughout as a “Future Listing Agreement.” For example, in consideration of a rebate, a buyer signs a Future Listing Agreement. This agreement stipulates that at a future point when the buyer wishes to sell the property, he/she/they must utilize the Future Listing Agreement beneficiary for listing the property. If there is a sale of the property without utilizing the Future Listing Agreement beneficiary as selling agent, then the Future Listing Agreement beneficiary is owed the amount originally paid to homeowner with or without interest.

The Future Listing Agreement may be recorded in a database or a distributed database utilizing a blockchain or similar technology. The Future Listing Agreement is thus handled as an asset that can be bought, sold, traded, and otherwise treated as a type of security/asset.

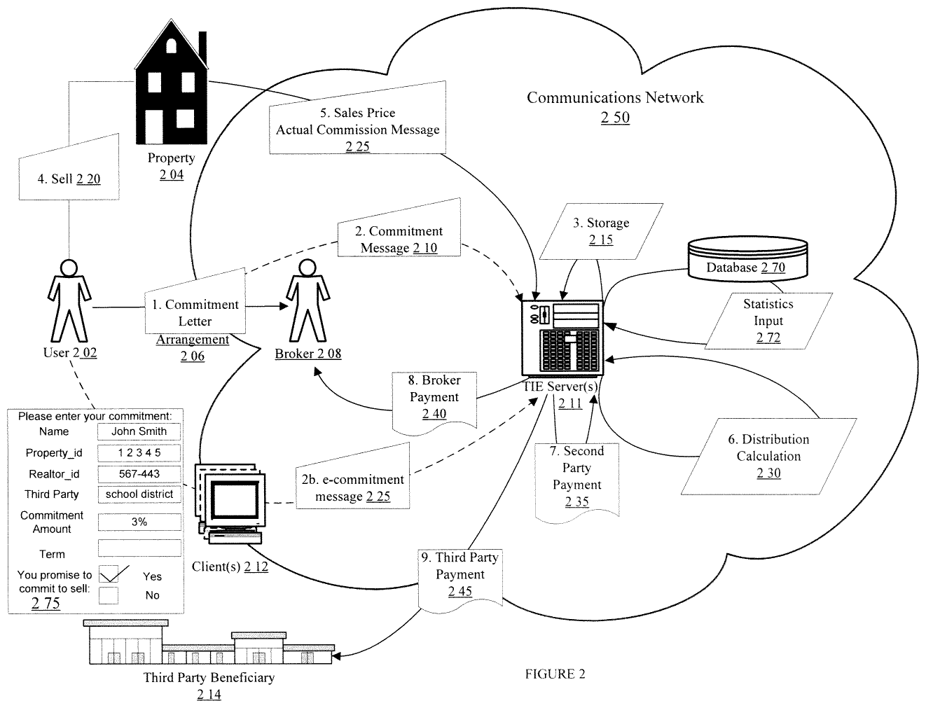

FIG. 2 illustrates some aspects in one embodiment of TIE operations. As illustrated in FIG. 2, some aspects of TIE operations may include a user 202, a broker 208, and a commitment letter. The arrangement 206 and commitment letter may be placed into a commitment message. In one embodiment, the broker's client 208 may send the commitment message 210 to the TIE server 211.

Alternatively, a property owner user 202 may input commitment information 275 through a client or client device 212, which may similarly result in the sending of an e-commitment message 225 to the TIE server 211. The TIE server may take the information received and store the data into a database 215, 270. At some time, the owner 202 will decide to and sell 220 their property 204. This may result in either the broker 208 or client 212 generating and sending a “sales prices/actual commission” message to the TIE server 225.

Upon the sale 220 of the property 204, the TIE server 211 may receive the sales price and/or actual commission message as input 225. In some embodiments, the TIE server may calculate commission proceed distribution amounts 230. In one embodiment, the TIE server distributes the computed proceed amounts to a broker 240, a second party 235 and/or a third party 245 beneficiary 214; e.g. effectuating a funds transfer. In one embodiment, the TIE server may receive statistics input from a database 270 and/or perform operations on the statistics input 272 based on received messages.

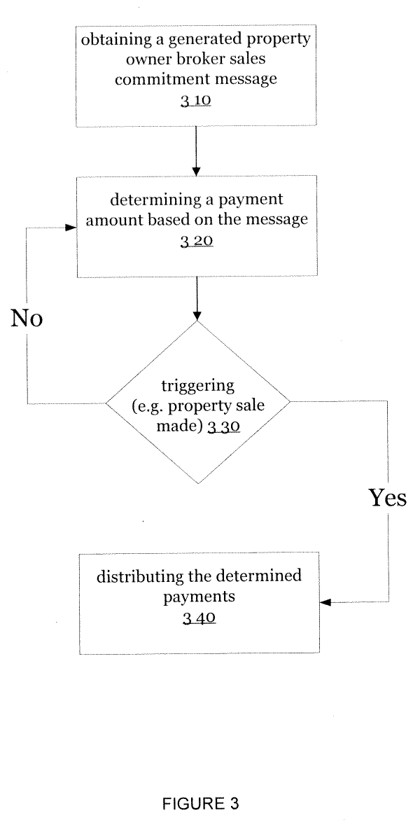

FIG. 3 illustrates aspects of one embodiment of TIE operations. As illustrated, the TIE includes obtaining a generated property owner broker sales commitment message 310. The TIE may also determine a payment amount based on the message 320. In one embodiment, the TIE may check to determine if a triggering condition is satisfied 330. One example of a triggering condition may be if the property has been sold. If the condition is not satisfied, the TIE may continue checking, e.g., determining a payment amount 320. If the condition is satisfied, the TIE server may distribute the determined payments 340.

### A. TIE Controller

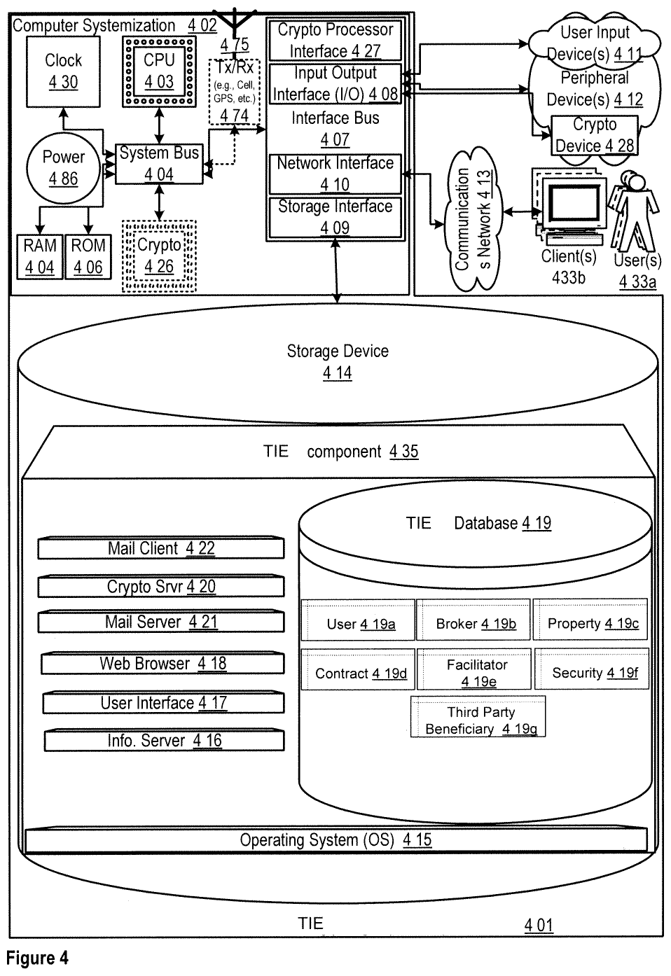

FIG. 4 shows one embodiments of the TIE controller. In this embodiment, the TIE controller 401 may serve to aggregate, process, store, search, serve, identify, instruct, generate, match, and/or facilitate interactions with a computer through commission distributing technologies, and/or other related data.

Users may engage information technology (e.g., computers) to facilitate information processing. In turn, computers employ processors to process information; such processors 403 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed include input and output mechanisms through which data may pass into and out of a computer; memory storage into which data may be saved; and processors by which information may be processed. These information technology resources may be used to collect data for later retrieval, analysis, and manipulation, which may be facilitated through a database program.

In one embodiment, the TIE controller 401 may be connected to and/or communicate with a processor 403 or central processing unit (“CPU”); one or more users from user input devices 411; peripheral devices 412; an optional cryptographic processor device 428; and/or a communications network 413.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers and/or clients across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The TIE controller 401 may be based on a computer systemization 402 connected to the TIE component 435.

### B. Computer Systemization

A computer systemization 402 may comprise a clock 430, central processing unit (“CPU(s)” and/or “processor(s)” (these terms are used interchangeable throughout the disclosure unless noted to the contrary)) 403, a memory (e.g., a read only memory (ROM) 406, a random access memory (RAM) 404, etc.), and/or an interface bus 407. These components may be interconnected and/or communicating through a system bus 404 on one or more (mother)board(s) 402 having conductive and/or otherwise transportive circuit pathways through which instructions (e.g., binary encoded signals) may travel to effectuate communications, operations, storage, etc. The computer systemization may be connected to a power source 486. The power source may be external or internal to the respective computer systemization. A cryptographic processor 426 and/or transceivers (e.g., ICs) 474 may be connected to the system bus. In another embodiment, the cryptographic processor and/or transceivers may be connected as either internal and/or external peripheral devices 412 via the interface bus I/O. The transceivers may be connected to antenna(s) 475, thereby effectuating wireless transmission and reception of various communication and/or sensor protocols. For example, the antenna(s) may connect to: a Texas Instruments WiLink WL1283 transceiver chip (e.g., providing 802.11n, Bluetooth 3.0, FM, global positioning system (GPS) (thereby allowing TIE controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-16 Gold 618-PMB9800 (e.g., providing 2G/3G HSDPA/HSUPA communications); and/or the like. The system clock may include a crystal oscillator and generates a base signal through the computer systemization's circuit pathways. The clock may be coupled to the system bus and various clock multipliers that may increase or decrease the base operating frequency for other components interconnected in the computer systemization. The clock and various components in a computer systemization may drive signals embodying information throughout. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in some embodiments, any of the above components may be connected directly to one another, connected to the CPU, and/or organized in numerous variations.

The CPU may comprise data processor(s) adequate to execute program components for executing user and/or TIE-generated requests. A processor may include specialized processing units. For example, a processor may include integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to data processing techniques. Such instruction passing facilitates communication within the TIE controller and beyond through various interfaces. Should processing requirements dictate a greater amount speed and/or capacity, distributed processors (e.g., Distributed TIE), mainframe, multi-core, parallel, and/or super-computer architectures may similarly be employed. Alternatively, should deployment requirements dictate greater portability, smaller Personal Digital Assistants (PDAs) may be employed.

Features of the TIE may be achieved by implementing a microcontroller such as CAST's R8051XC2 microcontroller; Intel's MCS 51 (i.e., 8051 microcontroller); and/or the like. Some feature implementations may include embedded components, such as: Application-Specific Integrated Circuit (“ASIC”), Digital Signal Processing (“DSP”), Field Programmable Gate Array (“FPGA”), and/or the like embedded technology. For example, any of the TIE component collection (distributed or otherwise) and/or features may be implemented via the microprocessor and/or via embedded components; e.g., via ASIC, coprocessor, DSP, FPGA, and/or the like. Alternately, some implementations of the TIE may be implemented with embedded components that are configured and used to achieve a variety of features or signal processing.

The embedded components may include software solutions, hardware solutions, and/or some combination of both hardware/software solutions. For example, TIE features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects may be programmed by the customer or designer to implement the TIE features. A hierarchy of programmable interconnects allow logic blocks to be interconnected as needed by the TIE administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. The TIE may be developed on FPGAs and/or migrated into a fixed version that more resembles ASIC implementations. Alternate or coordinating implementations may migrate TIE controller features to a final ASIC instead of or in addition to FPGAs. Embedded components and microprocessors may be considered the “CPU” and/or “processor” for the TIE.

### C. Power Source

The power source 486 may be of any form for powering electronic circuit board devices. Power cells may include alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 486 may be connected to at least one of the interconnected subsequent components of the TIE platform thereby providing an electric current to all subsequent components. In one example, the power source 486 is connected to the system bus component 404. In one embodiment, an outside power source 486 may be connected across the I/O 408 interface. For example, a USB and/or IEEE 1394 connection carries both data and power across the connection and is therefore a suitable source of power.

### D. Interface Adapters

Interface bus(ses) 407 may accept, connect, and/or communicate to a number of interface adapters, conventionally although not necessarily in the form of adapter cards, such as but not limited to: input output interfaces (I/O) 408, storage interfaces 409, network interfaces 410, and/or the like. Optionally, cryptographic processor interfaces 427 similarly may be connected to the interface bus. The interface bus provides for the communications of interface adapters with one another as well as with other components of the computer systemization. Interface adapters are adapted for a compatible interface bus. Interface adapters may connect to the interface bus via a slot architecture. Some slot architectures may include: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 409 may accept, communicate, and/or connect to a number of storage devices such as, but not limited to: storage devices 414, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 410 may accept, communicate, and/or connect to a communications network 413. Through a communications network 413, the TIE controller is accessible through remote clients 433b (e.g., computers with web browsers) by users 433a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed TIE), architectures may similarly be employed to pool, load balance, and/or otherwise increase the communicative bandwidth required by the TIE controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 410 may be used to engage with various communications network types 413. For example, multiple network interfaces may be employed to allow for the communication over broadcast, multicast, and/or unicast networks.

Input Output interfaces (I/O) 408 may accept, communicate, and/or connect to user input devices 411, peripheral devices 412, cryptographic processor devices 428, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 411 often are a type of peripheral device 412 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 412 may be connected and/or communicate to I/O and/or other facilities of the like such as network interfaces, storage interfaces, directly to the interface bus, system bus, the CPU, and/or the like. Peripheral devices may be external, internal and/or part of the TIE controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 428), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the TIE controller may be embodied as an embedded, dedicated, and/or monitor-less (i.e., headless) device, wherein access would be provided over a network interface connection.

Cryptographic units such as, but not limited to, microcontrollers, processors 426, interfaces 427, and/or devices 428 may be attached, and/or communicate with the TIE controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### E. Memory

Generally, any mechanization and/or embodiment allowing a processor to affect the storage and/or retrieval of information is regarded as memory 429. However, memory is a fungible technology and resource, thus, any number of memory embodiments may be employed in lieu of or in concert with one another. It is to be understood that the TIE controller and/or a computer systemization may employ various forms of memory. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory will include ROM 406, RAM 405, and a storage device 414. A storage device 414 may be any conventional computer storage. Storage devices may include a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### F. Component Collection

The memory may contain a collection of program and/or database components and/or data such as, but not limited to: operating system component(s) 415 (operating system); information server component(s) 416 (information server); user interface component(s) 417 (user interface); Web browser component(s) 418 (Web browser); database(s) 419; mail server component(s) 421; mail client component(s) 422; cryptographic server component(s) 420 (cryptographic server); the TIE component(s) 435; and/or the like (i.e., collectively a component collection). These components may be stored and accessed from the storage devices and/or from storage devices accessible through an interface bus. Although non-conventional program components such as those in the component collection, typically, are stored in a local storage device 414, they may also be loaded and/or stored in memory such as: peripheral devices, RAM, remote storage facilities through a communications network, ROM, various forms of memory, and/or the like.

### G. Operating System

The operating system component 415 is an executable program component facilitating the operation of the TIE controller. Typically, the operating system facilitates access of I/O, network interfaces, peripheral devices, storage devices, and/or the like. The operating system may be a highly fault tolerant, scalable, and secure such as: Apple Macintosh OS X (Server); AT&T Plan 9; Be OS; Unix and Unix-1 like distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. More limited and/or less secure operating systems may also be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the TIE controller to communicate with other entities through a communications network 413. Various communication protocols may be used by the TIE controller as a subcarrier transport mechanism for interaction, such as, but not limited to: multicast, TCP/IP, UDP, unicast, and/or the like.

### H. Information Server

An information server component 416 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the TIE controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the TIE database 419, operating systems, other program components, user interfaces, Web browsers, and/or the like.

Access to the TIE database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the TIE. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the TIE as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

In addition, an information server may contain, communicate, generate, obtain, and/or provide program component, user, and/or data communications, requests, and/or responses.

### I. User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 417 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components through textual and/or graphical facilities. The user interface provides a facility through which users may affect, interact, and/or operate a computer. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, user, and/or data communications, requests, and/or responses.

### J. Web Browser

A Web browser component 418 is a stored program component that is executed by a CPU. The Web browser may be a conventional hypertext viewing application such as Microsoft Internet Explorer or Netscape Navigator. Secure Web browsing may be supplied with 128bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, user, and/or data communications, requests, and/or responses. In addition, in place of a Web browser and information server, a combined application may be developed to perform similar operations of both. The combined application would similarly affect the obtaining and the provision of information to users, user agents, and/or the like from the TIE enabled nodes.

In an exemplary embodiment, a browser extension is used to direct a user-agent (browser) to a website where information about the original website is inferred/gathered. This information is used for displaying additional products and services to user.

Moreover, in exemplary embodiments, a textbox on a website allows a user to enter either an address, an MLS #, or a URL from a myriad of other websites. The website utilizes that input, in whatever form to gather data about the subject being entered and provide relevant information to a user. A website/application displays a mortgage rate (interest rate, points, monthly payment) that is variable, based on user-selected rebate amount. In other words, the user selects how much of a rebate (if any) they wish to receive, and the website displays different mortgage characteristics

### K. Mail Server

A mail server component 421 is a stored program component that is executed by a CPU 403. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C # and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the TIE.

Access to the TIE mail may be achieved through a number of APIs offered by the individual Web server components and/or the operating system.

In addition, a mail server may contain, communicate, generate, obtain, and/or provide program component, user, and/or data communications, requests, information, and/or responses.

### L. Mail Client

A mail client component 422 is a stored program component that is executed by a CPU 403. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### M. Cryptographic Server

A cryptographic server component 420 may include a stored program component that is executed by a CPU 403, cryptographic processor 426, cryptographic processor interface 427, cryptographic processor device 428, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to digital certificates (e.g., X.509 authentication framework), digital signatures, dual signatures, enveloping, password access protection, public key management, and/or the like. The cryptographic component is operable to facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the TIE may encrypt all incoming and/or outgoing communications and may serve as node within a virtual private network (VPN) with a wider communications network. The cryptographic component may facilitate the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to enable the TIE component to engage in secure transactions if so desired. The cryptographic component may facilitate the secure accessing of resources on the TIE and facilitates the access of secured resources one remote system. For example, the cryptographic component may act as a client and/or server of secured resources. In one embodiment, the cryptographic component communicates with information servers, operating systems, other program components, and/or the like. The cryptographic component may contain, communicate, generate, obtain, and/or provide program component, system, user, and/or data communications, requests, and/or responses.

### N. The TIE Database

The TIE database component 419 may be embodied in a database and its stored data. The database may include a stored program component, which may be executed by the CPU; the stored program component portion configuring the CPU to process the stored data. The database may be a conventional, fault tolerant, relational, scalable, secure database such as Oracle or Sybase. Relational databases are an extension of a flat file. Relational databases may comprise a series of related tables. In some embodiments, the tables may be interconnected or associated via a key field. Use of the key field allows the combination of the tables by indexing against the key field; i.e., the key fields act as dimensional pivot points for combining information from various tables. Relationships generally identify links maintained between tables by matching primary keys. Primary keys may represent fields that uniquely identify the rows of a table in a relational database. More precisely, they uniquely identify rows of a table on the “one” side of a one-to-many relationship.

In one embodiment, the TIE database may be implemented using various standard data-structures, such as an array, hash, (linked) list, struct, structured document, or text file (e.g., XML), table, and/or the like. Such data-structures may be stored in memory and/or in (structured) files. In one embodiment, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases where objects may include encapsulated capabilities. If the TIE database is implemented as a data-structure, the use of the TIE database 419 may be integrated into another component such as the TIE component 435. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 419 includes several tables 419a-g. A user table 419a may include fields such as, but not limited to: user_identifier, user_name, user_address, user_email, user_login, user_contact_number, user_bank_id, user_account_number, user_routing_number, and/or the like. The user table may support and/or track multiple user accounts on the TIE platform.

A broker table 419b includes fields such as, but not limited to: broker_identifier, broker_name, brokerage_name, broker_associations, broker_beneficiary, broker_address, broker_website, broker_login, broker_bank_id, broker_account_number, broker_routing_number and/or the like. The broker table may support and/or track multiple broker accounts on the TIE platform.

A property table 419c includes fields such as, but not limited to: property_identifier, property_name, property_type, property_address, property_owner, property_lot_number, property_purchase_price, property_assessment_value, property_taxes, property_maintenance_fees, property_neighborhood, property-school-district and/or the like. The broker table may support and/or track multiple property accounts on the TIE platform.

A contract table 419d includes fields such as, but not limited to: contract_identifier, contract_name, contract_type, contract_associations, contract_beneficiary, contract_seller, contract_broker and/or the like. The contract table may support and/or track multiple contract accounts on the TIE platform.

A facilitator table 419e includes fields such as, but not limited to: facilitator_identifier, facilitator_name, facilitator_associations, facilitator_fee, facilitator_address, facilitator_website, facilitator_login facilitator_bank_id, facilitator_account_number, facilitator_routing_number and/or the like. The facilitator table may support and/or track multiple facilitator accounts on the TIE platform.

A security table 419f includes fields such as, but not limited to: security_identifier, security_name, security_biometrics, security_associations, security_address, security_website, security_login, user security_id, broker_security_id, facilitator_security_id, beneficiary_security_id and/or the like. The beneficiary table may support and/or track multiple beneficiary accounts on the TIE platform.

A third party beneficiary table 419g may include fields such as: beneficiary_identifier, beneficiary_name, beneficiary_type, beneficiary_address, beneficiary_associations, beneficiary_website, beneficiary_login, beneficiary_bank_id, beneficiary_account_number, beneficiary_routing_number and/or the like. The beneficiary table may support and/or track multiple beneficiary accounts on the TIE platform.

In one embodiment, the TIE database may interact with other databases. For example, employing a distributed database, queries and data access by search TIE component may treat the combination of the TIE database, an integrated data security layer database as a single database entity.

In one embodiment, user programs may contain various user interface primitives, which may serve to update the TIE. Also, various accounts may require custom database tables depending upon the environments and the types of clients the TIE may need to serve. It should be noted that any unique fields may be designated as a key field throughout. In an alternative embodiment, these tables have been decentralized into their own databases and their respective database controllers (i.e., individual database controllers for each of the above tables). Employing advantageous data processing techniques, one may further distribute the databases over several computer systemizations and/or storage devices. Similarly, configurations of the decentralized database controllers may be varied by consolidating and/or distributing the various database components 419. The TIE may be configured to keep track of various settings, inputs, and parameters via database controllers.

The TIE database may communicate to and/or with other components in a component collection, including itself, and/or facilities of the like. Most frequently, the TIE database communicates with the TIE component, other program components, and/or the like. The database may contain, retain, and provide information regarding other nodes and data. Moreover, the Future Listing Agreement (aka, “property owner sales commitment”) may be recorded in a database or a distributed database utilizing a blockchain or similar technology.

### O. The TIEs

The TIE component 435 is a stored program component that is executed by a CPU. In one embodiment, the TIE component incorporates any and/or all combinations of the aspects of the TIE that was discussed in the previous figures. As such, the TIE affects accessing, obtaining and the provision of information, services, transactions, and/or the like across various communications networks.

In one embodiment, the TIE platform transforms illiquid equity, such as future commissions. The TIE platform transforms commitment message, e-commitment messages, sale price actual commission messages via TIE components into commission payment distribution amounts.

The TIE component enabling access of information between nodes may be developed by employing standard development tools and languages such as, but not limited to: Apache components, Assembly, ActiveX, binary executables, (ANSI) (Objective-) C (++), C # and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the TIE server employs a cryptographic server to encrypt and decrypt communications. The TIE component may communicate to and/or with other components in a component collection, including itself, and/or facilities of the like. Most frequently, the TIE component communicates with the TIE database, operating systems, other program components, and/or the like. The TIE may contain, communicate, generate, obtain, and/or provide program component, user, and/or data communications, requests, and/or responses.

### P. Distributed TIEs

The structure and/or operation of any of the TIE node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the TIE controller may depend on the context of deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:

w3c-post http:// . . . Value1

Where Value 1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of deployment.

For example, in some implementations, the TIE controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

TABLE 1
<?PHP
header(′Content-Type: text/plain′);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {

$input = “”;
$input = socket_read($client, 1024);
$data .= $input; 2

} while($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>

Also, the following resources may be used to provide example embodiments regarding SOAP parser implementation:

http://www.xav.com/perl/site/lib/SOAP/Parser.html

http://publib.boulder.ibm.com/infocenter/tivihelp/v2r1/index.jsp?topic=/com.ibm

.IBMDI.doc/referenceguide295.htm
And other parser implementations:

http://publib.boulder.ibm.com/infocenter/tivihelp/v2r1/index.jsp?topic=/com.ibm23

.IBMDI.doc/referenceguide259.htm all of which are hereby expressly incorporated by reference.

### Q. Exemplary Scenarios

The following summarizes some embodiments of the securitization structure and some of the issues arising with respect to the intended creation of a secondary market for PREP contracts. The program may begin with homeowners entering into a contract (the PREP contract) pursuant to which the homeowner may agree that whenever in the future the homeowner elects to sell his or her residence, the homeowner may give the sale listing to the real estate broker with whom he or she has entered into the PREP contract. The homeowner may be given consideration of $300 (either in cash or in the form of a gift card to a local merchant or some other form of consideration) and the real estate broker may agree that when the home is listed with that broker that the commission payable upon the sale may be 3.75% To further induce the homeowner to participate, the broker may agree to contribute directly or through PREP an amount equal to a percentage, for example, 0.5% of the sale price to the homeowners local school (or church or synagogue, etc.) of choice. PREP may also receive a commission from the broker, for example, about or equal to 0.5%.

Part of PREP's duties may be to essentially act as the servicer of the PREP contracts, maintaining up to date lists of the contracts initiated by participating brokers and arranging for appropriate notices to escrow once a homeowner elects to sell his or her home.

Once a participating broker has initiated a sufficient number of PREP contracts, the broker may transfer the PREP contracts into a special purpose entity (SPE) (a single member LLC or a wholly owned subsidiary). The purpose of that transfer may be to achieve, in some embodiments, to the maximum extent possible, bankruptcy remoteness with respect to the ownership and benefits to be derived from the PREP contracts

The SPE may issue, directly or through a newly created single purpose trust, securities the repayment of which may be tied directly and solely to the cash flow generated by the PREP contracts as homeowners elect to and ultimately sell their homes.

The securities to be issued that may be backed by the PREP contracts may not pay interest on a regular basis and may not have a specified maturity date. This is because it may be uncertain at this time just how quickly homeowners may elect to sell, how long it may take to effect a sale, and the amount of commissions that may be received that can be used to repay the securities.

As the securities may be subject to some uncertainties, it may be that while the SEC may re-write its Regulation AB that may control the public offering of asset-backed securities, it may be problematic and expensive to seek to register a public offering of PREP contract backed securities. Instead, it may be more effective to structure a Rule 144A offering or the like of such securities to a single or a plurality of purchasers (such as a hedge fund or bank or insurance company holding company). Such entities may work with issuers of emerging esoteric assets and assist in the effective structuring of such offerings. In one embodiment, once one or more of such transactions have been completed successfully, a public market for such securities may develop. While other ranges may be used, the initial pool for a private Rule 144A transaction may be in the $25 million to $50 million range

An offering may be public or private, may include a primary or secondary (shadow) rating agency rating. Accordingly, it may be advantageous for the transaction to undergo scrutiny by a rating agency and their involvement during the structuring phase may need to be factored into the timing and cost parameters.

The PREP process may simplify the enforceability and valuation of a PREP agreement or contract.

For example, a homeowner may enter into a contract today agreeing to list his or her home in the future with broker A. The homeowner may then terminate the contract without liability. If so, and he or she selects broker B to sell his or her home, there may be recourse from PREP against the homeowner or broker B. Additionally, a resolution may be in place if broker A dies, or if not an individual closes or is acquired by broker C.

As will be apparent to those of skill in the art, the PREP contract may be valued as a commodity. Presumably, the obligation to act as broker may or may not be transferred to the SPE, but the right to payment upon completion of the contract by broker A may be transferred. There are variables that may undergo rigorous testing to determine how a valuation matrix may work. Some of the variables may include: when the homeowner may elect to sell, the actual sale price of the home at an uncertain future date, how home values may fluctuate over time, the general condition of the national and local economy, lending rates, changes in tax policies (local taxes and deductibility of home mortgage interest payments) and the like.

The rating agency selected may raise other variables that it believes to be factors affecting the cash flow to be derived from the PREP contract assets in the pool. One may undergo negotiations with the rating agency over these issues and their affect. Rating agencies may stress test the valuation/cash flow model to determine what the minimum cash flow may ultimately be that may be available to pay the securities. In one embodiment, this minimum cash flow may then set the ceiling as to the maximum amount that may be raised upon the sale of a given pool of assets. In addition, the expected timing to achieve this minimum cash flow may then be used to fix the discount expected by the purchaser of the assets. Since the securities may or may not earn interest, the securities may have to be sold with substantial initial issue discount, much like zero coupon bonds, to give to investors the gain needed to attract them to the securities.

The structure may also be subject to a tax analysis. There may be a taxable sale when the contracts are sold to the SPE. If so, a tax deferral mechanism may be used. An initial issue discount, may affect the tax treatment for the securities once payment is made. It may be useful to obtain, store and mine analyses from one or more investment banks on asset-backed securities transactions to assist with valuation and criteria that may be used to assign a rating by the rating agency and/or investors. The investment banks analyses may also inform the structure of an offering to achieve an optimal potential return.

PREP may expect the process of moving from acquiring the first PREP contracts to completing a first securitization of a pool of such contracts will take time. It is not unusual for such new issuances of esoteric assets to take a year or more to reach an initial closing. PREP may also budget for other parties to the process may expect PREP to cover part of the legal, accounting and rating agency expenses of parties involved in the process.

The process “PREP” Property Rebate for Education Program is a unique way to fund local community organizations and institutions, and realize a profit. PREP may be for profit fund raising method and process. Better funded community' organizations/institutions (local schools, police etc.) equate to higher property values. Underfunded communities sometimes suffer property devaluation much more frequently and drastically then those communities that have adequate, or above adequate, funding. When property devaluates, fewer property taxes may be collected, and public services continue to decline, causing further erosion in property value. Music teachers, librarians, counselors, classroom size, upgraded police and emergency services, 6 new community facilities, all have an impact on property valuations because they improve the quality of life for each and every citizen.

The city of Agoura, Calif., may be one example of how public services drive real estate values. Every year there may be an exodus of families to Agoura Calif. from Los Angeles, because of its superior Blue Ribbon school district. Beverly Hills is an example of exceptional public services driving home valuations higher. The more demand, the tighter the supply, and consequently higher property values ensue. The PREP business process may be designed to raise property values by funding our local institutions through the sale, and/or sign up, of property owners or property buyers who elect to participate in the program. PREP is a novel, and unique way to raise money.

In one embodiment, the first advantageous participant in the PREP business process may be the Realtor/broker. The Realtor/broker may agree to donate a portion of their future commission(s) (on the sale of PREP participating homes) to specific key local organizations that have been determined to impact property values. In one embodiment, schools are the beneficiary, but any organization, charity, or institution can utilize the PREP method and process to raise needed funds. The Realtor/broker may receive consideration for their pledge, through additional real estate sales facilitated by the PREP process. One step may be a contract between a homeowner and their chosen real estate professional. The contract may designate what Realtor/Broker may represent the sale of the subject property, at a known or unknown future date. For example, a homebuyer agrees today to use his past Realtor, “Mary Kay Realtor,” to future list his home. At the time of signing, Joe Homeowner may not know when he may sell his home or even perhaps if he may sell his home. In return for the pre-commitment, Mary Kay Realtor may agree to donate a sizable portion of her future commission on that home, to a chosen entity (the beneficiary).

For Mary Kay Realtor, the more clients who pre-agree to use her services the more business she can expect in the future. Statistics show that the average home may be lived in for seven years before it transfers title. If Mary Kay Realtor is in possession of 100 pre-listing contracts, she can expect all one hundred (on average) to transfer ownership within that seven year period. Therefore, Mary Kay Realtor, may for the first time in her real estate career, make an estimated projection based upon solid data regarding her future income potential, Ex: 100/7=14.28 homes sold per year. If Mary Kay Realtor then adds a factor for defaults, she can come up with an expected rate of return on her pre-committed listings.

As an example, a licensed independent Realtor has rarely been able to project with any certainty when they may acquire another customer. This lack of certainty about where the next dollar may flow from may be one reason why the Realtor makes such a large commission. Sales people have made better money than most other professions because of the uncertainty that surrounds client acquisition. By using the PREP technique to acquire a new or former client, a Realtor may be on the hunt for pre-listings as well as current listings. Having a portfolio of executed pre-listing contracts enables the Realtor to transition from a transaction oriented salesperson, to a consultative and nurturing mentor of future clients. Much like picking a ripening crop, the crop of prelisted homes may bear fruit as time goes on. PREP pre-listing contracts may change the dynamics of the Realtors job.

Supporting PREP materials may contain data, charts, historical graphs, and projections that show, that the better funded our community services are, i.e., police, fire department, schools; the better likelihood the value of the local real estate is to maintain or rise in its value. These materials may be used in part to convince the homeowner that signing up for PREP may have a positive impact on their community and their home value. PREP presents new opportunities to build and strengthen our communities through its unique process. A property owner may add positive value to their property by pledging under an agreement to future list their property with a particular PREP associated/affiliated realtor/broker, the program has begun. The proposition to the Realtor is unique. By incentivizing a property owner to future list their property with a particular Realtor, the Realtor, in exchange, agrees to donate a portion or flat fee of their future commission to a chosen organization. This future commission pledge by the Realtor may be evidenced by a contract, and when the pledged home transacts (sells), the pledged Realtor may have been previously obligated to pay her agreed upon referral fee, to the pre-chosen civic organization. In some cases, the organization chosen to receive the eventual benefits of PREP, may be dictated by the participating homeowner or the PREP administrator.

PREP's systems and methods may fund local organizations and public institutions by leveraging unseen and rarely realized equity in a piece of property. This unrealized equity may travel with practically the piece of property that changes hands. The unrealized equity may be; the real estate commission paid to a broker when the property transfers ownership. Property owners may be inculcated to the fact that when they sell their home, a portion of their equity may be used to pay a real estate commission. By entering into a contract with the realtor/broker in advance, the homeowner can direct where a portion of the eventual commission ends up. The deal may be “sign up with me now and I may do something for the community you live in or the cause you believe in.”

Benefits from PREP may flow from the participating Realtors to local Boy's Clubs, YMCA's and local schools. Such funds may be used to hire and maintain music teachers, librarians, teachers' salaries, counselors, campus security, and the like.

The PREP system may incentivize a Realtor to make a donation that may benefit any entity wishing to raise funds as directed by the homeowner and/or the program administrator. The model may fund a variety of community organizations. If for example, the American Cancer Society decided to use the PREP process to raise money, they would simply ask their constituents to PREP their home to fight CANCER. In one embodiment, Realtors who service homes prominently in areas where our armed services personnel reside, such as Ft Hood, Tex., may be incentivized to give part of their commission to a military charitable cause. However, the value chain created through the PREP process may be the same: “Mr. Realtor” gets a future client that they may not have acquired, in exchange for a promised donation that in some way benefits a property owner's cause, and/or their community.

As such, each local PREP program may be customized to benefit the most compelling organization(s) that touch the lives of the residing homeowner participants. In one embodiment, the organizations chosen that may benefit property owner values may be the local school or district in which the homeowner participant resides. Better schools, higher home values. The PREP program may significantly increase funding for schools and organizations tied to the district, town, county, zip code in which the PREP homeowner participants reside. In one embodiment, The PREP program is not dependent upon a personalized incentive to an individual homeowner. In one embodiment, PREP raises the value of the communities by funding desirable projects dear to the hearts of their homeowner participants.

One result of a Realtor signing up with PREP, and in turn getting their current and former clients to join up, may be more money for local community organizations and more job stability for the Realtor professional. The PREP process may enable the Realtor to have more financial certainty in their life by allowing them to categorize and age their pre-listing contracts, to extrapolate likely future income.

The Pre-listing contract may be a document that proposes the terms and conditions upon which the homeowner wishes to sell their home, but, in the future with a known or unknown date. In some embodiments, pre-listings may have specific termination dates. In some states, it may be contemplated that the contract may need to be renewed every five years.

In one embodiment the contract may be binding, but there may or may not be a penalty if the homeowner decides to opt out and sell their home through a non-participating PREP Realtor. The homeowner may be encouraged through marketing resources to keep their pledge with the Realtor who signed them up, or at the very least enroll or nominate their new Realtor to join the program. In one embodiment, the homeowner may not incur costs for participating. In one embodiment, reminders may be sent to property owners, reminding them that they have made a commitment to their community that benefits the denizens there. In one embodiment, the PREP process may create a collective gift from the community members who may end up benefiting from that gift.

The model may create a secondary market where executed Pre-listing contracts may be purchased in bulk by an entity such as a hedge fund, insurance company or other buyer of secondary market paper. In one embodiment, the valuation may include a valuation of each contract. From a purchaser's perspective, this may include a calculation of the amount of commissions that may be generated from the sale of participant homes over a given period of time.

The return calculation may include processing a conglomeration of publicly available data and empirical data derived from the program itself. The data may include, but not be limited to, all or most of the data presented a set of indices, such as the Case Shiller Real Estate Futures Indices. This may include projections based upon past performance of real estate in a given market, including but not limited to the average time a home is owned before it hypothecates to another individual. The data may include the average price of the homes and the projected appreciation or depreciation as the case may be.

In one embodiment, a fair market value on the contract(s) may be established by tying in specific data criteria. Once created, a market may develop that may fund education and organizations. As the data solidifies, the value of the contract to the secondary market may commoditize, and pricing may stabilize. The more established the data, the more stable the projections of the return. A stable contract may be worth far more than an unknown entity. Therefore, it may take a predetermined time for the value of these contracts to establish themselves. In one embodiment, the claimed technique includes a Future Listing Market Place (FLMP). This marketplace may be derived from a PREP listed home and may offer the real estate professional an opportunity to borrow on or pledge their contracts as a type of security. The Realtor/broker may factor the new instrument for consideration. PREP contracts may become a viable way to raise needed capital for any real estate brokerage.

POST PLEDGE REVENUE OPPORTUNITIES: Tangential income may be generated by offering a “soup to nuts” marketing solution for the Realtor. An example might be a $399.00 per year fee whereby the homeowner client may receive a personalized quarterly newsletter, pumpkins on Halloween, a birthday card, and various discounts throughout the years. The more pledges a Realtor has committed to, the better terms they receive on their personalized marketing solution. In fact, a homeowner who really wants to thank the pledging Realtor, or who needs to command additional money for their pledge, may even allow the Realtor special marketing privileges such as placing a small sign On their lawn stating: “This home Pledged to “Mary Kay. Realtor” The placement of these signs on the front lawns of pledged homes offers the era estate community unique marketing exposure. A sign showing the home is pledged but not yet up for sale, with the Realtors advertising on it, may become a staple as PREP becomes ever more popular. Realtors who have garnered the most PREP contracts may be known in their community for their support. More business may flow to Realtors from this exposure.

PREP CHANGES THE DYNAMICS OF THE BROKER/AGENT RELATIONSHIP: PREP may also be useful in retaining licensed real estate agents within a brokerage. Some agents tend to move with the best deal being offered to them by brokers, so it may not be uncommon for the broker businessperson to expend significant dollars to acquire and train a Realtor recruit.

Advantageously, PREP may solve this exodus problem in the Real Estate Brokerage business. Because the PREP pre-listing contract may be owned by the employing broker, an agent working under that broker, may naturally think twice about abandoning their executed PREP contracts to move to another agency. These contracts may serve as golden incentives on the agent or sales person. In one embodiment, this economic incentive to stay(the retaining of future business that was tirelessly and expensively acquired) may shift the dynamics of the Broker/Agent relationship, and place the Broker in a more reliable business position. Also, those brokerages who adopt PREP may attract talent from other brokerages that do not utilize the PREP process. With a number of executed PREP contracts, these contracts may be put up for purchase on a secondary market. A market is provided that did not exist before PREP. A market created by the existence of the PREP business model, method, and process. Real Estate brokerage firms may one day leverage all or part of their pre-listing contracts for working capital. Additionally, the PREP business model may include pre-agreements for real estate services, such as Escrow Companies, Title Companies, Appraisers, home warranty companies, and other professional services tied to the purchase or sale of a property. Furthermore, PREP is not exclusively for the home seller. The homebuyer may also agree in advance to use a certain realtor to buy a home through. That Realtor may agree in the pre-buyers contract to donate a portion of their commission to the community the homebuyer may be moving into. PREP changes the methods by which a buyer or seller enter into a contract with a real estate professional. It is conceivable that the PREP process may keep a home or a buyer “off the commercial market” for a specified time as the pre-listing and pre-buyer contract foreclose much of the opportunity for a competitor to acquire a PREP home listing. After all, if the client has pre-committed to buy or sell a home with a particular brokerage or agent, that commitment may take the transaction off the prospective marketplace.

The technique known as PREP Property Rebate for Education Program may be a unique way to fund local community organizations and institutions, and realize a profit. PREP may be a for-profit fund raising method and process. Better funded community' organizations/institutions (local schools, police etc.) equate to higher property values.

Underfunded communities suffer property devaluation than those communities that have adequate, or above adequate, funding. When property devaluates, fewer property taxes are collected, and public services continue to decline, causing further erosion in property value. Music teachers, librarians, counselors, classroom size, upgraded police, and emergency services, new community facilities, all have a direct impact on property valuations because they improve the quality of life for each and every citizen.

The PREP business process may be designed to raise property values by funding our local institutions through the sale, and/or sign up, of property owners or property buyers who elect to participate in the program. PREP may be a unique way to raise money.

One advantageous participant in the PREP business process may be the Realtor/broker. For PREP to work, the Realtor/broker can agree to donate a portion of their future commission(s) (on the sale of PREP participating homes) to specific key local organizations that have been determined to impact property values. Schools may be the beneficiary, but any organization, charity, or institution can utilize the PREP method and process to raise needed funds.

In one embodiment, the Realtor/broker receives consideration for their pledge, through additional real estate sales facilitated by the PREP process. One step may include a contract between Joe homeowner and their chosen real estate professional. The contract may designate which Realtor/Broker may represent the sale of the subject property, at a known or unknown future date. For example, a property owner agrees today to use his past Realtor, Mary Kay Realtor, to future list his home. At the time of signing Joe Homeowner may not know when he may sell his home or even perhaps if he may sell his home. In return for the pre-commitment, Mary Kay Realtor agrees to donate a sizable portion of her future commission on that home, to a chosen entity (the beneficiary).

For Mary Kay Realtor, the more clients who pre-agree to use her services the more business she can expect in the future. Statistics show that the average home may be lived in for seven years before it transfers title. If Mary Kay Realtor is in possession of 100 pre-listing contracts, she can expect all one hundred (on average) to transfer ownership within that seven year period.

In one embodiment, the Realtor may estimate projections based upon data regarding her future income potential. For example, 100/7=14.28 homes sold per year. If Realtor then adds a factor for defaults, she can come up with an expected rate of return on her pre-committed listings.

In the real estate industry, a licensed independent Realtor has rarely been able to project with certainty when they may acquire another customer. It has traditionally been catch as catch can. This lack of certainty about where the next dollar may flow from may be a key reason why the Realtor makes such a large commission. For the most part, sales people have made better money than most other professions because of the uncertainty that surrounds client acquisition. By using the PREP business method to acquire a new or former client, a Realtor may be on the hunt for pre-listings as well as current listings. Having a portfolio off executed pre-listing contracts enables the Realtor to transition from a transaction-oriented salesperson, to a consultative and nurturing mentor of future clients. Much like picking a ripening crop, the crop of prelisted homes may bear fruit as time goes on. PREP pre-listing contracts may change the dynamics of the Realtors job.

Supporting PREP materials may contain data, charts, historical graphs, and projections that directly show through a preponderance of evidence, that the better funded our community services are, i.e., police, fire department, schools; the better likelihood the value of the local real estate is to maintain or rise in its value. These materials may be used in part to convince the homeowner that signing up for PREP may have a positive impact on their community and their home value.

In one embodiment, PREP may present new opportunities to build and strengthen our communities through its unique method/process. Once a property owner may be convinced that they may add positive value to their property by pledging under a written contract to future list their property with a particular PREP associated/affiliated realtor/broker, the program has begun. The proposition to the Realtor may be unique. By incentivizing a property owner to future list their property with a particular Realtor, the Realtor, in exchange, agrees to donate a portion of their future commission to a locally chosen organization. This future commission pledge by the Realtor may be evidenced by a contract, and when the pledged home transacts (sells), the pledged Realtor may have been previously obligated to pay her agreed upon referral fee, to the pre-chosen civic organization. In one embodiment, the organization chosen to receive the eventual benefits of PREP, may be dictated by the participating homeowner or the PREP administrator.

In some embodiments, PREP's systems and methods are designed specifically to fund local organizations and public institutions by leveraging unseen and rarely realized equity in a piece of real property. This unrealized equity may travel with property that changes hands. The unrealized equity may be; the real estate commission paid to a broker when the property transfers ownership. Property owners may be inculcated to the fact that when they sell their home, a portion of their equity may be used to pay a real estate commission. By entering into a contract with the realtor/broker in advance of plans to sell, the homeowner can direct where a portion of the eventual commission ends up. The deal may be sign up with me now and I may do something for the community you live in or the cause you believe in. Benefits from PREP may flow from the participating Realtors to local Boy's Clubs, YMCAs, and schools. Such funds may be used to hire and maintain music teachers, librarians, teacher's salaries, counselors, campus security, and the like.

In one embodiment, the PREP system incentivizes a Realtor to make a donation that may benefit any entity wishing to raise funds as directed by the homeowner and/or the program administrator. The model is not solely designed to fund community organizations. For example, the American Cancer Society may decide to use the PREP process to raise money, they would simply ask their constituents to PREP their home to fight CANCER. In one embodiment, realtors who service homes prominently in areas where our armed services personnel reside, such as Ft Hood, Tex., may be incentivized to give part of their commission to a military charitable cause. In one embodiment, value chain created through the PREP business process is the similar: Mr. Realtor gets a future client, that they may not have acquired, in exchange for a promised donation, that in some way benefits a property owner's cause, and/or their community.

In one embodiment, a localized PREP program may be customized to benefit the most compelling organization(s) that touch the lives of the residing homeowner participants. The chosen organizations may include the local school district. Better schools, higher home values. In one embodiment, The PREP program increases funding for schools and organizations tied to the district, town, county, zip code in which the PREP homeowner participants reside. The PREP program is not dependent upon a personalized incentive to an individual homeowner. In one embodiment, the PREP program may raise the value of entire communities by funding desirable projects dear to the hearts of their homeowner participants.

In one embodiment, the result of a realtor signing up with PREP, and in turn getting their current and former clients to join up, may be more money for local community organizations and more job stability for the Realtor professional. The PREP process may enable the Realtor to have more financial certainty in their life by allowing them to categorize and age their pre-listing contracts, to extrapolate likely future income.

In one embodiment, the Pre-listing contract may be a document that proposes the terms and conditions upon which the homeowner wishes to sell their home, but, in the future with a known or unknown date. With embodiments able to conform to different property laws and regulations, pre-listings may have specific termination dates. For example, a California contract may be renewed every five years.

Although this contract may be binding, there may be no penalty if the homeowner decides to opt out and sell their home through a non-participating PREP Realtor. The homeowner may be encouraged through marketing resources to keep their pledge with the Realtor who signed them up, or at the very least enroll or nominate their new Realtor to join the program. The cost to homeowner to enter the program may be nominal or moderate and may depend on the specified flexibility to opt out. In one embodiment, the PREP process creates a collective gift from the community members who may end up benefiting from that gift.

In one embodiment, the program creates a secondary market where executed Pre-listing contracts can be purchased in bulk by an entity such as a hedge fund, insurance company or other buyer of secondary market paper. The value of each contract from may be the amount of commissions that may be generated from the sale of participant homes over a given period of time, i.e. the return calculation may be a conglomeration of publicly available data and empirical data derived from the program itself. The data may include, but not be limited to, all or most of the data presented by the Case Shiller Real Estate Futures Indices. This includes projections based upon past performance of real estate in a given market, including but not limited to the average time a home may be owned before it hypothecates to another individual. The data may include the average price of the homes and the projected appreciation or depreciation as the case may be. By tying in specific data criteria, much of which may be a fair market value on the contract(s) can be established. The market may fund education and organizations. As the data solidifies, the value of the contract to the secondary market may commoditize, and pricing may stabilize. The more established the data, the more stable the projections of the return. A stable contract may be worth far more than an unknown entity.

POST PLEDGE REVENUE OPPORTUNITIES: Tangential income may be generated by offering a soup to nuts marketing solution for the Realtor. An example might be a $399.00 per year fee whereby the homeowner client may receive a personalized quarterly newsletter, pumpkins on Halloween, a birthday card, and various discounts throughout the years. The more pledges a Realtor has committed to, the better terms they receive on their personalized marketing solution. In fact, a homeowner who really wants to thank the pledging Realtor, or who needs to command additional money for their pledge, may even allow the Realtor special marketing privileges such as placing a small sign on their lawn stating: This home Pledged to Mary Kay. Realtor The placement of these signs on the front lawns of pledged homes offers the era estate community unique and novel marketing exposure, that heretofore has not been an option. The idea of a sign that shows the home may be pledged but not yet up for sale, with the Realtors advertising on it, may become a staple as PREP becomes ever more popular. Realtors who have garnered the most PREP contracts may be known in their community for their support. More business may flow to Realtors from this exposure.

Real Estate brokerage firms may one day leverage all or part of their pre-listing contracts for needed working capital.

Additionally, the PREP business model contemplates pre-agreements for needed and/or essential real estate services, such as Escrow Companies, Title Companies, Appraisers, home warranty companies, and other professional services tied to the purchase or sale of a property.

Furthermore, PREP is not exclusively for the home seller. The homebuyer may also agree in advance to use a certain realtor to buy a home through.

The PREP Property Rebate for Education Program is a unique way to fund local community organizations and institutions, and realize a profit. PREP may be a for-profit fund raising method and process. Supporting PREP materials may contain data, charts, historical graphs, and projections that directly show through a preponderance of evidence, that the better funded our community services are, i.e., police, fire department, schools; the better likelihood the value of the local real estate is to maintain or rise in its value. These materials may be used in part to convince the homeowner that signing up for PREP may have a positive impact on their community and their home value.

PREP presents new opportunities to build and strengthen our communities through its unique method/process. Property owners may add positive value to their property by pledging under a written contract to future list their property with a particular PREP associated/affiliated realtor/broker. The proposition to the Realtor is unique. By incentivizing a property owner to future list their property with a particular Realtor, the Realtor, in exchange, agrees to donate a portion of their future commission to a locally chosen organization. This future commission pledge by the Realtor may be evidenced by a contract, and when the pledged home transacts (sells), the pledged Realtor may have been previously obligated to pay her agreed upon referral fee, to the pre-chosen civic organization. In most cases, the organization chosen to receive the eventual benefits of PREP, may be specified by the participating homeowner or the PREP administrator.

PREP's systems and methods are designed to fund local organizations and public institutions by leveraging unrealized equity in a piece of real property. This unrealized equity travels with practically every piece of property that changes hands in America. The unrealized equity may be; the real estate commission paid to a broker when the property transfers ownership. Property owners may be inculcated to the fact that when they sell their home, a portion of their equity may be used to pay a real estate commission. By entering into a contract with the realtor/broker in advance of plans to sell, the homeowner can direct where a portion of the eventual commission ends up.

In one embodiment, the result of a Realtor signing up with PREP, and in turn getting their current and former clients to join up, may be more money for local community organizations and more job stability for the Realtor professional. The PREP process enables the Realtor to have more financial certainty in their life by allowing them to categorize and age their pre-listing contracts, to extrapolate likely future income.

In one embodiment, homebuyer may also agree in advance to use a certain realtor to buy a home through. That Realtor may agree in the pre-buyers contract to donate a portion of their commission to the community the homebuyer may be moving into.

A facilitator may manage the process by developing a universal customizable application whereby any entity wishing to raise funds may be able to download a computer systemization, computer program, or application and customize it to their organization's constituents. The application may include a Future Listing Contract (FLC), but may also contain data that groups, clusters or otherwise tags FLC contracts by their risk factor. The risk factor may be helpful to an investor. In one embodiment, FICO scores, commitment level of contract, home value or assessment, number of years the resident has lived in the home, expected year of selling, nomination of their favorite realtor or company (which may in turn send that agent or company an invite to participate and may automatically send the agent or firm an agreement to execute (with perhaps a time limit) and may give other inside nominations of agency/realtors who are on a preferred list, with a rating. In one embodiment, the website may receive a data structure representing the realtors and firms nominated by others to make auto-suggestions. In one embodiment, the site may be customizable allowing the parties to view the information in a dashboard interface with dashboard elements and sub-elements.

In one embodiment, there may be a personal application allowing a property owner to pledge their future listing commission to themselves or a third party of their choice. The application may benefit the property owner, and simply may be a way to list a piece of property and direct a portion of the commission to oneself. For example, a property owner may self-pledge 25% of the commission. In one embodiment, the contract commitment level on the WIIFM (What is in it for me) contract may be enforceable with either a pre-payment penalty if the commitment is not followed through or the contracts may be attached to the title of the home. Attaching a commitment to the title of a home may require a recorded document, such as a lien, and the WIIFM site may contain all the materials for a homeowner to pledge the discount for the benefit of themselves or others of their choice, and auto record the document for their benefit. In one embodiment, the contract may be exclusively for those that choose the benefit for themselves.

An Example: Each unit of a condominium or an apartment complex may be governed by the building HOA, which has recently assessed an $8,000.00 fee for renovations to the common areas. The homeowners are in revolt over this. There are 200 units in the building, the average price of a unit may be $400K, and in the boom time, it was $450,000. If all 200 units signed an FLC for the benefit of the assessment, a large portion of the assessment would be paid for and thus the 8K bill would be reduced. The matrix of value for these contracts may be dictated by factors Jonathan Hollander is modeling, and ultimately what a purchaser of these FLC's may pay on a secondary market.

Web Embodiment: Note that the customer may download an application. In one embodiment, the user may have a web-based portal to define campaigns, track progress/sign ups, etc.

Prep Securitization: School Funding Solutions may include a partnership with reality brokerages.

The securitization summary introduces an instrument that arbitrages the client acquisition cost of a Realtor or Real Estate firm, as an example since other industries are equally applicable to this model, by alleviating much of that cost. In one embodiment, this may be accomplished through a contract called an FLC future-listing contract with the homeowner. The cost to the homeowner/property owner may be zero or nominal, the benefits to the property owner may be quite significant.

In one embodiment, the Realtor/Firm may agrees to a 25% referral fee, or some other percentage or flat fee on the 2.5% (or average or actual) commission, usually the selling side Realtor, but in some instances both selling and buying side, SFS may donate 50% of the proceeds to the local school or district the property owner resides within. In one embodiment, the end result increases property values and introduces better quality of life. More teachers, counselors, librarians, music and dance teachers and programs, etc. that a community can offer its residents, the higher the ultimate property value in those areas. The homeowner component may be one of the advantageous parts of the equation as the homeowner simply signs an FLC (future listing contract) which terms may vary state by state. Again, there may be no cost to the homeowner whatsoever.

PREP may be not limited to giving to schools. Any charity or organization can benefit if their constituents/stakeholders PREP their home. Another advantage is the potential for a market for these FLC's on the secondary market, prior to the homes transacting.

Community Funding Solutions (CFS) may be a unique for-profit fundraising method and process: a cutting-edge and unparalleled way to fund local community organizations, institutions, charities, while realizing a profit. However, Community Funding Solutions may be associated or administered through a non-profit entity. In some embodiments, CFS may operate in the same or similar manner as the PREP program and SFS, described above.

In one embodiment, CFS may not impact property values. Ft Hood Texas may be an example of a geographic and demographic area where the military is woven into the fabric of daily life. For that area, the beneficiary that may motivate a pledge may not be the local schools but, or in addition to the schools, a Military Charitable Cause. The Community Funding Solutions business process may be designed to funding local institutions, organizations, etc., through property sales with the direct participation of property owners & buyers. In addition to being an incomparable sales tool for the real estate industry, Community Funding Solutions may be a unique and singular way to raise money for matters that touch a property owner's life. In one embodiment, the participants in the Community Funding Solutions business process may be the Realtor/broker and the property owner. Community Funding Solutions may begin with the Realtor/broker agreeing to donate a portion of his future commission(s) (from the sale of Community Funding Solutions participating homes) to specific key local organizations that have, in most cases, been determined to impact property values. Schools are the may be one beneficiary, but any organization, charity, or institution can utilize Community Funding Solutions to raise needed funds. The Realtor/broker may benefit as additional real estate sales are facilitated by and through the Community Funding Solutions process.

In one embodiment, a contract forms between the Property Owner/buyer and his chosen real estate professional/agency. The contract may designate what Realtor/Broker may represent the sale of the subject property, at a known or unknown future date. The more clients who pledge to use a realtor's services, the more business the realtor can expect in the future. Some Statistics show that the average home may be lived in for X # years before it transfers title. If the Realtor is in possession of one hundred pre-listing contracts, the realtor may expect one hundred (on average) to transfer ownership within that X year time frame. Therefore, Realtor may estimate projection of future income potential based upon solid data (ex: 100/X=Y homes sold per year). If Realtor adds a factor for defaults, realtor can come up with an expected rate of return on her pre-committed listings.

In one embodiment, a portfolio of executed pre-listing contracts enables the Realtor to transition from a transaction-oriented salesperson to a consultative and nurturing mentor of future clients. The unrealized equity (e.g., agent's commission) may travels with a commission based sales transaction. In one embodiment, the unrealized equity may be the real estate commission paid to a broker when the property transfers ownership. In one embodiment, a portion of a property owner's equity may be used to pay a real estate commission. By entering into a contract with the Realtor/broker in advance of plans to sell, the Property Owner can direct where a portion of the eventual commission ends up.

The Community Funding Solutions system may require Realtors to make a donation that may benefit any entity wishing to raise funds as directed by the Property Owner and/or the program administrator. Community Funding Solutions may have a Website whereby the Property Owner participant can nominate a Realtor or company of their choice, where a property owner can email, fax a pledge and they may immediately see the funds transferred to their organization in real time or not. An instrument that may help alleviate the client acquisition cost of a Realtor or Real Estate firm., by alleviating much of that cost. This may be accomplished through a contract called an FLC future listing contract with the homeowner. The cost to the homeowner/property owner may be ZERO, the benefits to the property owner are quite significant

### R. Summary

In order to address various issues and advance the art, the entirety of this application for APPARATUSES, METHODS AND SYSTEMS FOR TRANSFORMING ILLIQUID EQUITY PLATFORM (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. In addition, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a TIE individual and/or enterprise user, database configuration and/or relational model, data type, data transmission and/or network framework, syntax structure, and/or the like, various embodiments of the TIE, may be implemented that enable a great deal of flexibility and customization. For example, aspects of the TIE may be adapted for any commission based or incentivized revenue structure. While various embodiments and discussions of the TIE have been directed to the real estate and finance industry, however, it is to be understood that the embodiments described herein may be readily configured and/or customized for a wide variety of other applications and/or implementations.

The present invention has been described above in terms of presently preferred embodiments so that an understanding of the present invention can be conveyed. However, there are other embodiments not specifically described herein for which the present invention is applicable. Therefore, the present invention should not to be seen as limited to the forms shown, which is to be considered illustrative rather than restrictive.

What is claimed is:

1. A computerized method for illiquid equity transformation, comprising:
receiving from a client device via digital communication, at a network-based system, a generated property owner broker sales (POBS) commitment messaging, the POBS messaging including owner data, broker data, property data, and contract data detailing a future listing agreement between the a property owner and a broker to be encumbered upon a real estate property of the owner;
accessing, at the network-based system, a database management system (DBMS) that maintains user data, broker data, property data, and contract data, based on the POBS messaging;
determining a payment amount due to the property owner based upon data provided in the POBS messaging, via a controller of the network-based system, the controller in digital communication the DBMS, the controller configured to issue a plurality of processing instructions to calculate the payment amount; and
transmitting, from the network-based system, payment instructions for the payment amount.

2. The method as defined in claim 1, wherein the owner data of the POBS messaging includes a property owner identifier.

3. The method as defined in claim 1, wherein the broker data of the POBS messaging includes a specified broker identifier.

4. The method as defined in claim 1, wherein the POBS messaging includes a specified third-party beneficiary identifier.

5. The method as defined in claim 1, wherein the property data of the POBS messaging includes a property identifier.

6. The method as defined in claim 5, wherein the contract data of the POBS messaging includes a broker property sales commitment data, detailing an actual sales price and an actual commission amount for the real estate property.

7. The method as defined in claim 5, wherein the determining step further includes calculating a listing service payment amount, and transmitting step further includes the payment instructions including the listing service payment amount.

8. The method as defined in claim 5, wherein the determining step further includes calculating a third-party beneficiary payment amount, and transmitting step further includes the payment instructions including the third-party beneficiary payment amount.

9. A network-based system for illiquid equity transformation, comprising:
a client device in digital communication with at the network-based system, the client device generates a property owner broker sales (POBS) commitment messaging, the POBS messaging including owner data, broker data, property data, and contract data detailing a future listing agreement between the a property owner and a broker to be encumbered upon a real estate property of the owner;
a server assembly of the network-based system in in digital communication with the client device via a network;
a database management system (DBMS) of the network-based system that maintains user data, broker data, property data, and contract data, based on the POBS messaging receiving via the server assembly; and
a controller assembly of the network-based system, the controller in digital communication the DBMS, the controller programmed:
to determine a payment amount due to the property owner based upon data provided in the POBS messaging, to calculate the payment amount, and to
transmit, from the network-based system, payment instructions for the payment amount.

10. The system as defined in claim 9, wherein the owner data of the POBS messaging includes a property owner identifier.

11. The system as defined in claim 9, wherein the broker data of the POBS messaging includes a specified broker identifier.

12. The system as defined in claim 9, wherein the POBS messaging includes a specified third-party beneficiary identifier.

13. The system as defined in claim 9, wherein the property data of the POBS messaging includes a property identifier.

14. The system as defined in claim 13, wherein the contract data of the POBS messaging includes a broker property sales commitment data, detailing an actual sales price and an actual commission amount for the real estate property.

15. The system as defined in claim 13, wherein the determining step further includes calculating a listing service payment amount, and transmitting step further includes the payment instructions including the listing service payment amount.

16. The system as defined in claim 13, wherein the determining step further includes calculating a third-party beneficiary payment amount, and transmitting step further includes the payment instructions including the third-party beneficiary payment amount.
